(19) United States
(12) Patent Application Publication
(10) Pub. No.: US 2011/0074178 A1
(43) Pub. Date: Mar. 31, 2011

(54) Glare shield apparatus

(75) Inventors: Tadashi Saitoh, Fukui-city (JP); Seio Omura, Sabae-city (JP)

(73) Assignee: SANKOH CO., LTD., Sabae city (JP)

(21) Appl. No.: 12/654,083

(22) Filed: Dec. 10, 2009

(30) Foreign Application Priority Data
Sep. 30, 2009 (JP) 2009-227652

(51) Int. Cl. B60J 3/02; B60J 3/00

(52) U.S. Cl. 296/97.6

(57) ABSTRACT

A glare shield apparatus that allows a glare shield to be removably attached to a sun visor provided in a vehicle such as an automobile includes a clip that removably attaches the glare shield to the sun visor so that the glare shield can be rotated between a rest position and a use position, a guide frame that is fitted to the glare shield from an upper long side of the glare shield to a halfway position of each short side of the glare shield, a portion of the guide frame that is fitted to each short side of the glare shield being formed as a guide section that guides a movement of the glare shield, and positioning means that is included in at least one of the guide section and the glare shield, and positions the glare shield at a withdrawn position or a pull-out position.

### BACKGROUND

The present invention relates to a glare shield apparatus that allows attachment of a glare shield to a sun visor provided above the driver's seat of an automobile, for example.

For example, at least the front side, the right side, and the left side of the driver's seat of a vehicle (e.g., automobile) are covered with transparent glass in order to ensure the driver's view. Safe driving may be hindered when sunlight (daytime) or a light beam emitted from the headlights of the oncoming car or the following car (nighttime) comes into the driver's view either directly or via a rear view mirror. Therefore, vehicles are normally equipped with a sun visor that reduces the effects of external light (e.g., sunlight).

However, a standard sun visor is not necessarily satisfactory when sunlight almost horizontally comes into the driver's view in the morning or evening, or a light beam emitted from the headlights of the oncoming car or the following car comes into the driver's view either directly or via a rear view mirror.

In order to solve this problem, various glare shield apparatuses have been proposed (see JP-A-2003-112524, JP-A-2002-362156, and JP-A-2002-127744, for example).

However, the fixtures disclosed in these documents have a complex configuration and are expensive. In particular, the mechanism disclosed in JP-A-2003-112524 and JP-A-2002-362156 that automatically changes the direction of the fixture corresponding to a relative change in the incident direction of sunlight further increases complexity and cost.

### SUMMARY

The present invention was conceived in view of the above situation. An object of the present invention is to provide a glare shield apparatus that has a simple configuration, can be produced at low cost, allows the direction of the glare shield to be arbitrarily changed corresponding to the incident direction of sunlight, and is suitable for a vehicle sun visor.

According to one aspect of the present invention, there is provided a glare shield apparatus that allows a glare shield to be removably attached to a sun visor provided in a vehicle such as an automobile, the glare shield apparatus comprising:

a clip that removably attaches the glare shield to the sun visor so that the glare shield can be rotated between a rest position and a use position;

a guide frame that is fitted to the glare shield from an upper long side of the glare shield to a halfway position of each short side of the glare shield, a portion of the guide frame that is fitted to each short side of the glare shield being formed as a guide section that guides a movement of the glare shield; and
positioning means that is included in at least one of the guide section and the glare shield, and positions the glare shield at a withdrawn position or a pull-out position.

According to this configuration, the glare shield is normally placed at the rest position along the sun visor, and can be rotated to the use position, if necessary. Since the glare shield is attached to the sun visor via the clip, the attachment position of the glare shield with respect to the sun visor can be arbitrarily changed.

In the above glare shield apparatus, the positioning means may include a groove that is formed in the guide section, an upper stopper that is formed on the glare shield at a position corresponding to the groove and comes in contact with a lower end of the groove at the pull-out position, and a lower stopper that can move beyond the lower end of the groove in a pull-out direction and engages the lower end of the groove when the glare shield is situated at the withdrawn position.

In the above glare shield apparatus, the position of the glare shield with respect to the clip may be able to be adjusted in a forward/backward direction. The above glare shield apparatus may further comprise a lateral direction slide mechanism that allows the glare shield to be slidingly moved laterally with respect to the clip.

According to the present invention, a glare shield apparatus that has a simple configuration, can be produced at low cost, allows the direction of the glare shield to be arbitrarily changed corresponding to the direction of sunlight, and is suitable for a vehicle sun visor, can be provided.

### BRIEF DESCRIPTION OF THE DRAWINGS

FIG. 1A is a front view illustrative of the configuration of a glare shield apparatus according to one embodiment of the present invention, and FIG. 1B is an enlarged cross-sectional view showing a guide section of the glare shield apparatus shown in FIG. 1A.

FIG. 2A is a plan view showing a clip of the glare shield apparatus shown in FIG. 1A, and FIG. 2B is a view illustrative of a ratchet mechanism for a rotating shaft.

FIGS. 3A to 3C are views illustrative of a use state of a glare shield apparatus according to the present invention.

FIG. 4 is a view illustrative of a use state of a glare shield apparatus according to the present invention.

FIG. 5 is a front view showing a glare shield apparatus according to another embodiment of the present invention.

FIG. 6 is a side view showing a glare shield apparatuses according to still another embodiment of the present invention.

### DESCRIPTION OF EXEMPLARY EMBODIMENTS

Preferred embodiments of the present invention are described in detail below with reference to the drawings.

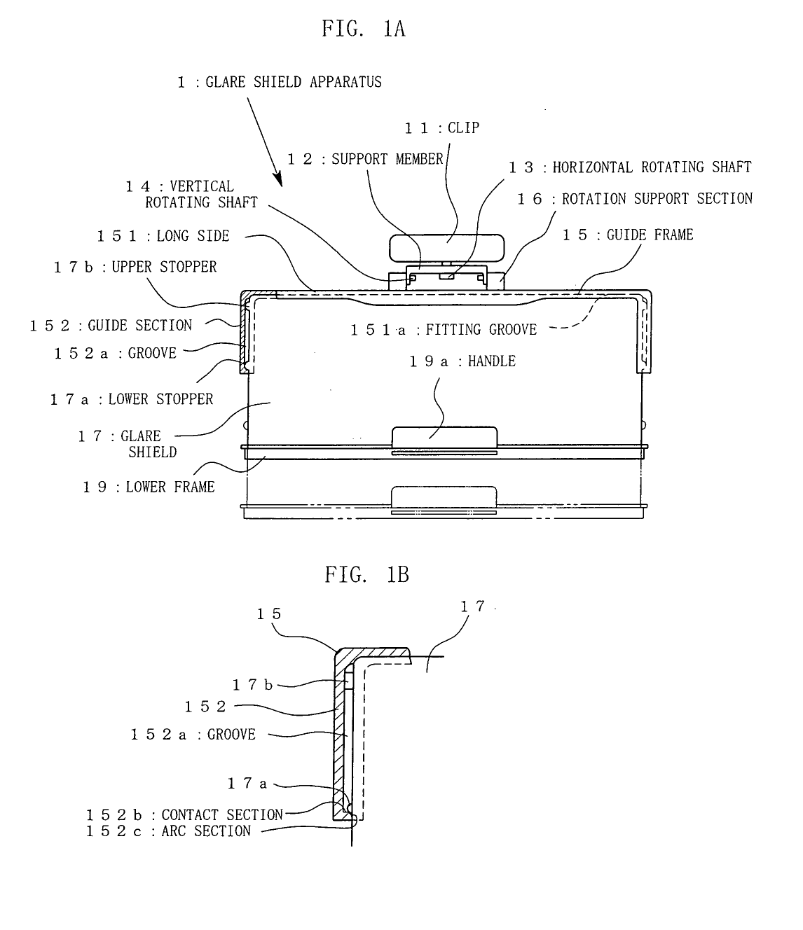

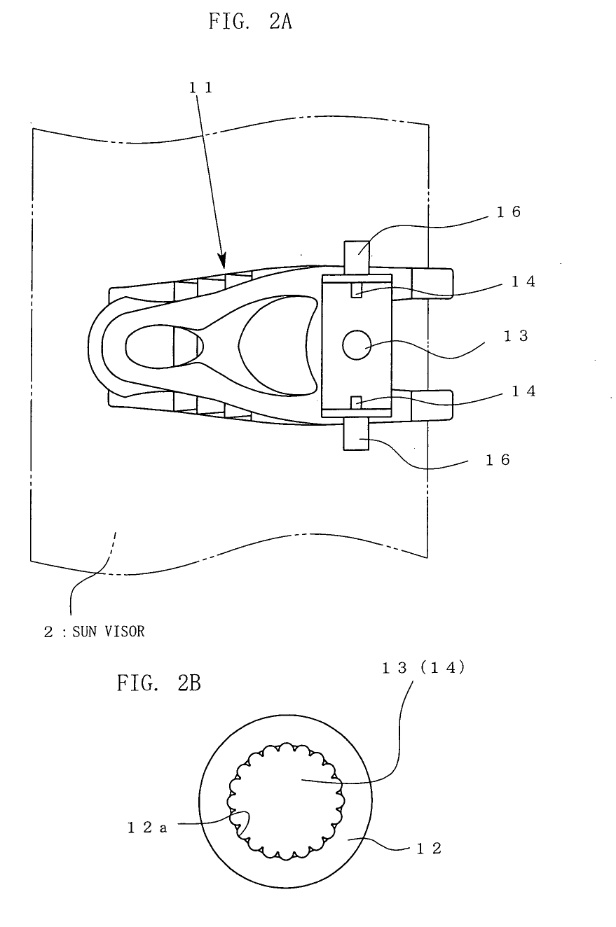

FIG. 1A is a front view illustrative of the configuration of a glare shield apparatus according to one embodiment of the present invention, FIG. 1B is an enlarged cross-sectional view showing a guide section of the glare shield apparatus shown in FIG. 1A, FIG. 2A is a plan view showing a clip of the glare shield apparatus shown in FIG. 1A, and FIG. 2B is a view illustrative of a ratchet mechanism for a rotating shaft.

As shown in FIG. 1A, a glare shield apparatus 1 according to this embodiment includes a clip 11 that is used to removably attach a translucent glare shield 17 that can effectively reduce external light (e.g., sunlight) and does not hinder the driver's vision to a sun visor of an automobile.

The glare shield 17 is preferably formed using a polarizer. The glare shield 17 according to this embodiment is formed in the shape of a rectangle having two long sides (top and bottom) and two short sides (right and left), and is rotatably attached to the clip 11 via a support member 12.

The clip 11 is not limited to the configuration shown in FIG. 1A insofar as the glare shield 17 can be removably attached to a sun visor of an automobile. Various clips may be used as the clip 11.

The support member 12 is formed approximately in the shape of the letter “U” that opens downward (see FIG. 1A), and is attached to the clip 11 via a horizontal rotating shaft 13 that is inserted into the center of the bottom of the support member 12 so that the support member 12 can be rotated horizontally with respect to the clip 11.

A vertical rotating shaft 14 is inserted into the sidewall of the support member 12 on each side of the bottom of the support member 12. The glare shield 17 is attached to the support member 12 via the vertical rotating shafts 14 so that the glare shield 17 can be rotated in the vertical direction (i.e., flip-up/flip-down direction).

A guide frame 15 is fitted to the glare shield 17. The guide frame 15 is formed approximately in the shape of the letter “U” that opens downward, and extends from the upper long side of the glare shield 17 to a halfway position of each short side of the glare shield 17. A fitting groove 151a is formed along the inner circumferential surface of the guide frame 15. The long side and the short sides of the glare shield 17 are fitted into the fitting groove 151a.

Each side of the guide frame 15 is formed as a guide section 152 that guides a slide movement of the glare shield 17. A groove 152a is formed at the bottom of the fitting groove 151a formed in the guide section 152. Upper and lower protrusions (i.e., upper stopper 17b and lower stopper 17a) that engage the groove 152a are formed on the short side of the glare shield 17.

A contact section 152b is formed at the lower end of the groove 152a, the contact section 152b coming in contact with the upper stopper 17b to restrict a further slide movement of the glare shield 17 so that the glare shield 17 does not come off from the guide frame 15.

The end of the contact section 152b is formed as an arc section 152c so that the lower stopper 17a that is formed in the shape of a semicircle and is smaller than the upper stopper 17b causes the guide section 152 to be elastically deformed (stretched) while slidingly coming in contact with the arc section 152c such that the lower stopper 17a can move beyond the lower end of the groove 152a. This makes it possible to bring out the glare shield 17 from the guide frame 15.

The guide frame 15 is preferably formed of a resin material (e.g., silicone resin or acrylic resin), but may be formed of a metal (e.g., aluminum).

Two rotation support sections 16 protrude from the center of the guide frame 15 so that the support member 12 is positioned between the rotation support sections 16. The vertical rotating shaft 14 around which the glare shield 17 is rotated in the vertical direction is inserted into the support member 12 and supported by the rotation support section 16.

As shown in FIG. 2B, the horizontal rotating shaft 13 or the vertical rotating shaft 14 can be stopped by a ratchet mechanism at an arbitrary rotational angle with respect to a through-hole 12a formed in the support member 12.

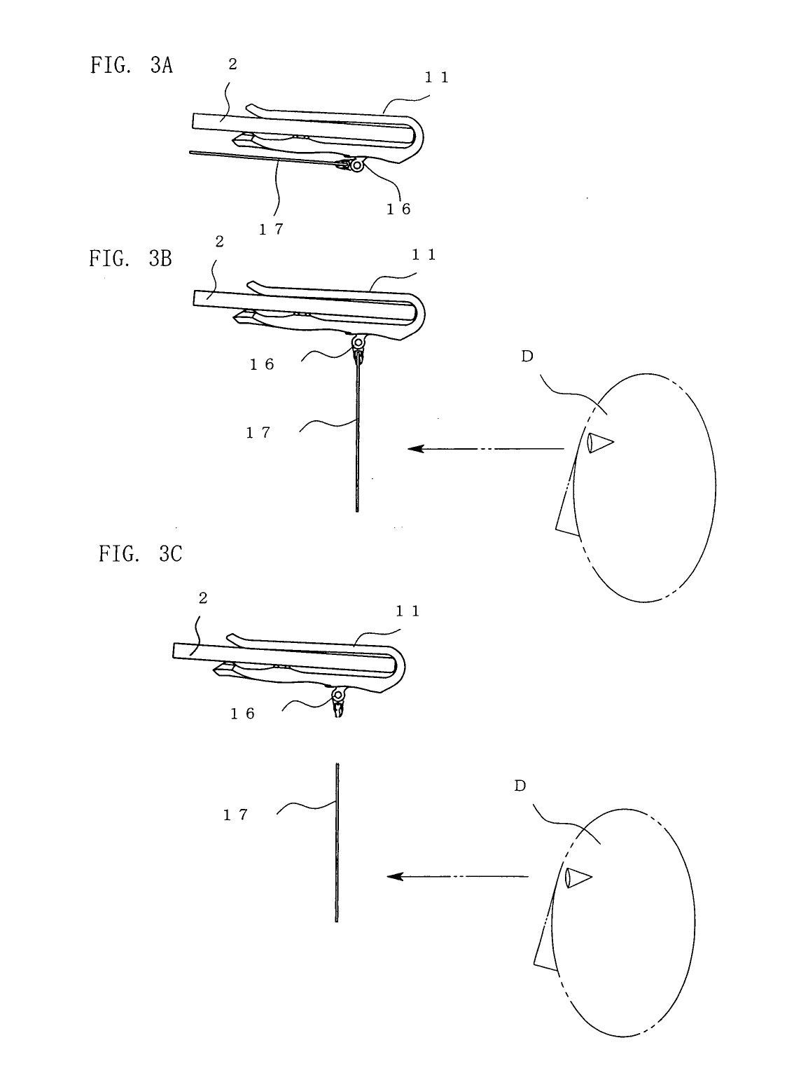

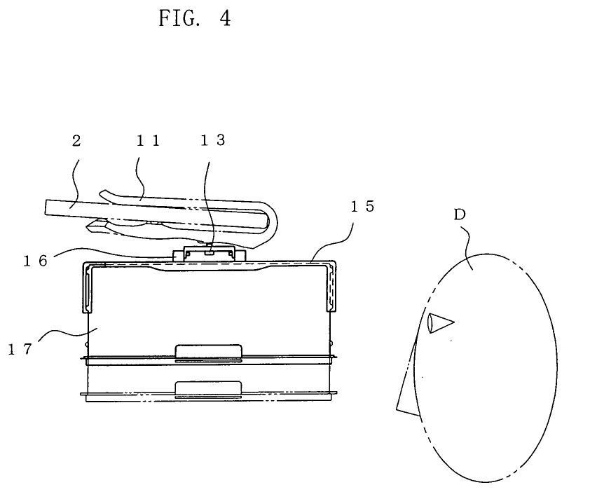

FIGS. 3A to 3C and FIG. 4 are views illustrative of a use state of the glare shield apparatus 1 according to the present invention.

When it is unnecessary to use the glare shield 17, the glare shield 17 is rotated upward and held along the bottom surface of the sun visor 2 (see FIG. 3A).

When it is necessary to use the glare shield 17, the glare shield 17 is rotated downward and positioned vertically in front of a driver D (see FIG. 3B).

When the driver is of small stature, the glare shield 17 may not properly function if the glare shield 17 is normally positioned. In this case, the glare shield 17 is slidingly moved downward (see FIG. 3C). This makes it possible for the glare shield 17 to help such a driver.

When sunlight is laterally incident on the driver D, the glare shield 17 is rotated sideways with respect to the clip 11 so that the glare shield 17 faces the sunlight incident direction (see FIG. 4).

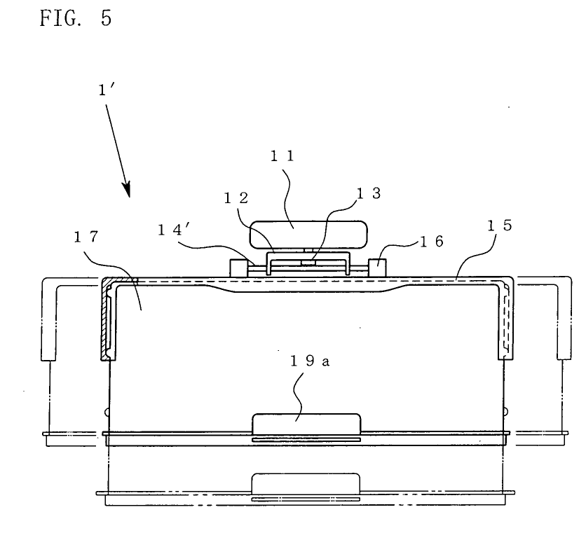

FIG. 5 is a front view showing a glare shield apparatus according to another embodiment of the present invention.

Note that the members (sections) identical to those of the above embodiment are indicated by the identical reference numerals, and detailed description thereof is omitted.

A glare shield apparatus 1′ according to this embodiment is configured so that the distance between the rotation support sections 16 disposed at the center of the guide frame 15 is greater than the width of the support member 12. A single vertical rotating shaft 14′ is suspended between the rotation support sections 16 so that the ends of the vertical rotating shaft 14′ are supported by the rotation support sections 16. Elevations and depressions are formed over the outer circumferential surface of the vertical rotating shaft 14′ from one end to the other end so that the support member 12 functions as a ratchet mechanism irrespective of its position with respect to the vertical rotating shaft 14′.

According to this configuration, the glare shield 17 can be slidingly moved to the right and left together with the rotation support section 16 by the distance between the support member 12 and the rotation support section 16.

A glare shield apparatus according to still another embodiment of the present invention includes a mechanism that allows the glare shield 17 to be slidingly moved forward and backward.

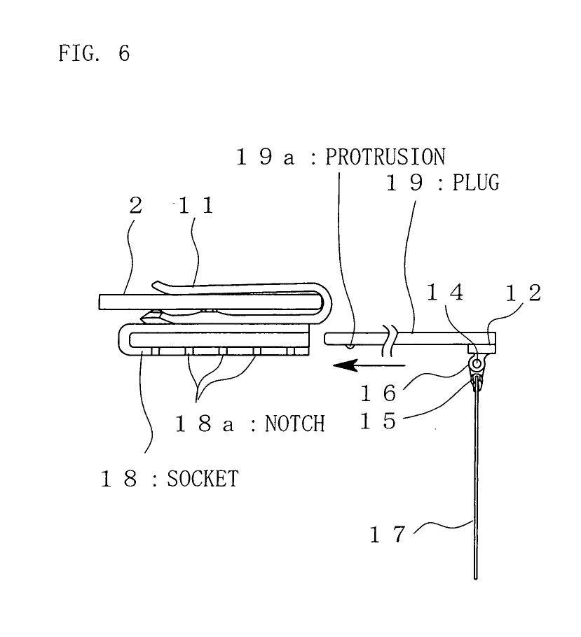

FIG. 6 is a side view showing a glare shield apparatus according to this embodiment of the present invention.

A socket 18 is integrally provided under the clip 11, and notches 18a are formed in the socket 18 at given intervals along the insertion direction. The support member 12, the rotation support section 16, the guide frame 15, the glare shield 17, and the like are provided on one end of a plug 19 that can be removably inserted into the socket 17. A protrusion 19a that engages the notch 18a formed in the socket 18 is formed on the plug 19. The horizontal position of the glare shield 17 with respect to the clip 11 can be adjusted by changing the engagement position of the protrusion 19a with the notch 18a while moving the plug 19 forward and backward with respect to the socket 18.

Preferred embodiments of the present invention have been described above. Note that the connection structure according to the present invention is not limited to those described in the above embodiments.

For example, the above embodiments have been described taking an example in which the positioning means that positions the glare shield 17 at the withdrawn position or the pull-out position includes the upper and lower stoppers 17a and 17b formed on the glare shield 17, the groove 152a, the contact section 152b, the arc section 152c, and the like. Note that the configuration of the positioning means is not limited thereto insofar as the same effects can be achieved. Various known mechanisms may be used as the positioning means. For example, the glare shield 17 may be positioned by utilizing friction with the guide frame, or the glare shield 17 may be gradually pulled out using a ratchet mechanism.

The present invention may be applied to sun visors for vehicles (e.g., passenger car, truck, bus, and train), aircraft, ships, and the like.

What is claimed is:

1. A glare shield apparatus that allows a glare shield to be removably attached to a sun visor provided in a vehicle such as an automobile, the glare shield apparatus comprising:
a clip that removably attaches the glare shield to the sun visor so that the glare shield can be rotated between a rest position and a use position;
a guide frame that is fitted to the glare shield from an upper long side of the glare shield to a halfway position of each short side of the glare shield, a portion of the guide frame that is fitted to each short side of the glare shield being formed as a guide section that guides a movement of the glare shield; and
positioning means that is included in at least one of the guide section and the glare shield, and positions the glare shield at a withdrawn position or a pull-out position.

2. The glare shield apparatus according to claim 1, wherein the positioning means includes a groove that is formed in the guide section, an upper stopper that is formed on the glare shield at a position corresponding to the groove and comes in contact with a lower end of the groove at the pull-out position, and a lower stopper that can move beyond the lower end of the groove in a pull-out direction and engages the lower end of the groove when the glare shield is situated at the withdrawn position.

3. The glare shield apparatus according to claim 1, wherein the position of the glare shield with respect to the clip can be adjusted in a forward/backward direction.

4. The glare shield apparatus according to claim 1, further comprising a lateral direction slide mechanism that allows the glare shield to be slidingly moved laterally with respect to the clip.
